(19) United States
(12) Patent Application Publication
(10) Pub. No.: US 2024/0232785 A9
(43) Pub. Date: Jul. 11, 2024

(54) Fuel Delivery Service Software Application For Mobile Devices

(71) Applicant: Gas to Go LLC, Flower Mound, TX (US)

(72) Inventor: Greg Crouse, Flower Mound, TX (US)

(73) Assignee: Gas to Go LLC, Flower Mound, TX (US)

(21) Appl. No.: 18/485,113

(22) Filed: Oct. 11, 2023

Related U.S. Application Data
(60) Provisional application No. 63/417,768, filed on Oct. 20, 2022.

(51) Int. Cl. G06Q 10/083; B60S 5/02; G06Q 20/14; G06Q 30/0601; H04L 9/40

(52) U.S. Cl. CPC G06Q 10/083; B60S 5/02; G06Q 20/145; G06Q 30/0621; G06Q 30/0643; H04L 63/083

(57) ABSTRACT

In general, in one aspect, embodiments relate to a method that includes providing access to a software application stored at an offsite storage location to one or more processing devices, the software that includes architecture, where the architecture is configured to display a home overlay, one or more additional overlays, and data from a database, allowing a user to download the software to the one or more processing devices, fulfilling a service request based on a service selection made by the user, where the service request includes at least delivery of one or more combustible fuels to a fuel recipient at an identified location.

### CROSS-REFERENCE TO RELATED APPLICATIONS

The present application is a non-provisional application of provisional U.S. Patent Application No. 63/417,768 filed Oct. 20, 2022, the entire disclosure of which is incorporated herein by reference.

### BACKGROUND

The automobile industry has seen an increase in manufacturing and sales of electric vehicles. It is anticipated that at some point in the future, electric vehicles will have displaced many of the gasoline-powered vehicles and by extension, demand for petroleum fuel such as gasoline. Although this displacement of gasoline-powered vehicles by electric vehicles is anticipated to be gradual, it is reasonable to expect that the general availability of petroleum fuels will decline and that at least a certain small number of car collectors will continue to demand petroleum fuels on at least a sporadic basis. It will therefore be needed in the future to deliver petroleum fuels to car collectors.

### SUMMARY

Disclosed herein is an example method that includes providing access to a software application stored at an offsite storage location to one or more processing devices. The software comprises architecture, which is configured to display a home overlay, one or more additional overlays, and data from a database. The method further includes allowing a user to download the software to the one or more processing devices and fulfilling a service request based on a service selection made by the user. The service request includes at least delivery of one or more combustible fuels to a fuel recipient at an identified location.

Further disclosed herein is an example software application that includes architecture. The architecture is configured to display a home overlay, one or more additional overlays, and data from a database. The software application is configured to trigger fulfillment of a service request based on a service selection made by a user. The service request comprises at least delivery of one or more combustible fuels to a fuel recipient at an identified location.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

These drawings illustrate certain aspects of some of the embodiments of the present invention and should not be used to limit or define the invention.

FIG. 1 illustrates a schematic of a fuel delivery system, in accordance with some examples.

FIG. 2 illustrates a schematic of a communication diagram between a processing device and a network offsite storage, in accordance with some examples.

FIG. 3 shows a graphical user interface provided by a processing device, in accordance with some examples.

FIG. 4 shows interrelated components of a processing device, in accordance with some examples.

FIG. 6 illustrates architecture between a user interface and a communication interface, in accordance with some examples.

FIG. 6 illustrates a schematic of a workflow in accordance with certain embodiments of the present disclosure.

### DETAILED DESCRIPTION

It is to be understood that the present disclosure is not limited to particular devices or methods, which may, of course, vary. It is also to be understood that the terminology used herein is for the purpose of describing particular embodiments only and is not intended to be limiting. All numbers and ranges disclosed herein may vary by some amount. Whenever a numerical range with a lower limit and an upper limit is disclosed, any number and any included range falling within the range are specifically disclosed. Although individual embodiments are discussed herein, the invention covers all combinations of all those embodiments. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this invention.

This disclosure may generally relate to systems and methods for marketing, selling, reserving, and delivering products or services. More particularly, certain aspects of this disclosure relate to a downloadable software application for a mobile device for a fuel delivery service.

As mentioned previously, it is anticipated that the general availability of fuel will see a gradual decrease at some point in the future due to a preponderance of electric and/or hybrid vehicles having lower fuel consumption. Certain embodiments of the present disclosure possess an improved ability to provide “on-demand” fuel delivery services at the convenience of buyers. Systems related to such embodiments, particularly programmable software applications, may have an improved ability to conveniently connect buyers with vendors via graphical user interfaces displayed on mobile devices. In addition, certain embodiments of the present disclosure may have an improved ability to enable and/or simplify delivery of on-demand fuel and allow users to conveniently log in to, view, select, reserve, and/or pay for fuel delivery services.

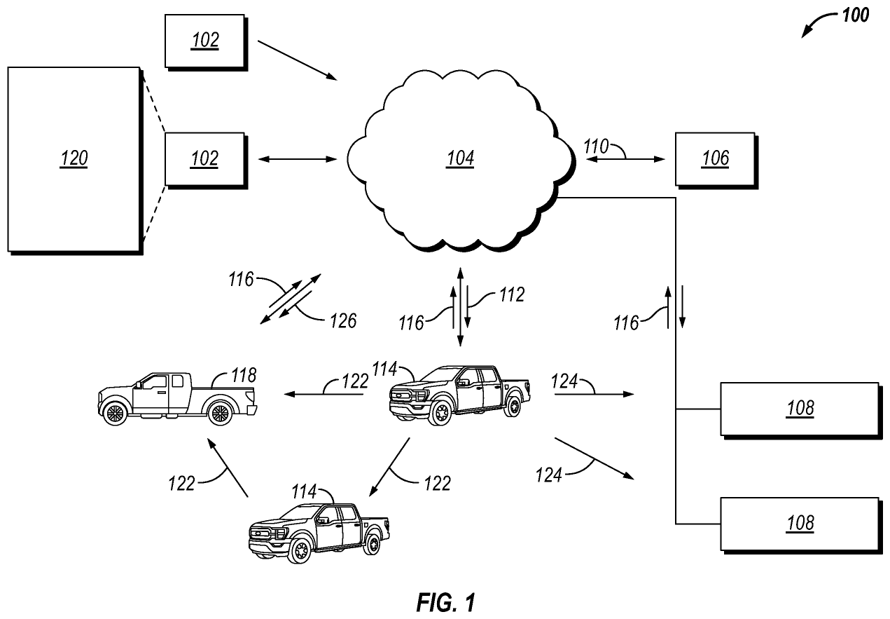

FIG. 1 is a schematic of a system 100 according to certain embodiments. As shown, a system 100 may comprise one or more servers 102, a network 104, one or more processing devices 106, and one or more fuel sources 108. A server 102 may comprise a computer and/or a system configured to provide any of a resource, data, a service, a program, and the like to one or more recipient computers or systems. Network 104 may comprise any number of interconnected nodes configured to transmit, receive, and/or exchange data. A network 104 may be in signal communication with any of one or more servers 102, computational hardware linked to one or more sources of fuel 108, one or more autonomous vehicles, one or more mobile devices, and/or combinations thereof. A network 104 may be in signal communication with one or more additional servers, which may comprise, for example, a cloud server. Where used, a cloud server may be primarily tasked with generating routing and/or mapping instructions. Alternatively, or additionally, one or more processing devices 106 may be in signal communication with one or more servers 102, one or more couriers 114, one or more databases 120, one or more computers, and/or computational hardware, or else one or more servers 102 may be in signal communication with one or more processing devices 106, couriers 114, computational hardware, etc. Herein, the phrase “signal communication” refers to any analog, digital, radio, optical, wired, wireless, electric, electronic, transitory, or non-transitory signal transmittable or receivable by one or more system components. In operation, at least a processing device 106 communicates via a network 104 with a server 102.

The purchaser may trigger using, for example, a processing device 106, the generation of an order 110 for fuel and/or fuel additive(s). That order 110 may be accompanied with additional information and may be sent to a server 102. A purchaser using a processing device 106 to make a request may be the same, or different from, fuel recipient 118. Types of fuel for selection may comprise gasoline, diesel fuel, bio-diesel fuel, ethanol, butanol, synthetic fuel, electro-fuel, e-fuel, carbon-captured fuel, premium fuel, a race gas, a treated gas, a high octane rated fuel, a low octane rated fuel, a zero-ethanol rated fuel, a high-grade fuel, a low-grade fuel, diesel, unleaded gasoline, natural gas (e.g., compressed natural gas, liquified natural gas, methane, ethane, propane, butane, etc.), and/or combinations thereof. “Carbon-captured fuel” refers to fuel, which is derived from carbon capture technologies, e.g., combustible fuel formed from atmospheric carbon dioxide. Types of additives to the fuel for selection may comprise octane, acetone, ether, nitrous oxide, fuel stabilizers, fuel injector cleaners, diesel exhaust fluid, nitromethane, a detergent, a ring sealer, butyl rubber, ferox, oxyhydrogen, ferrous picrate, tetranitromethane, anti-foaming agents, antioxidants, hybrid compound blends, oxygenates, antiknock agents, lead scavengers, fuel dyes, metal deactivators, corrosion inhibitors, and any combinations thereof. It should be understood that each and every teaching herein provided with respect to fuel delivery may be substituted with, or performed in conjunction with, delivery of one or more types of fuel additives. In operation, server 102 may receive additional information that may have been previously stored for the purchaser. Such additional information received by the server 102 may comprise, without limitation, the user's name, location, vehicle, purchase history, personal preferences, and personal settings, for example. An order 110 to purchase the requested fuel may be generated and may be based on the request, purchaser information, and any additional information.

In operation, instructions 112 are generated, for example, by a computer-implemented software using the order 110 and any additional information. Instructions 112 generated by a computer may comprise, to use non-limiting examples, routing information, an address, estimated time of arrival, fuel delivery information, purchase information, user identifier information such as license plate, make and model, and/or car color, identity and/or quantity of fuel, identity and/or quantity of fuel additives, mapping information, fuel description, identity or location of one or more fuel sources 108, purchaser's name, purchaser's location, purchaser's address, purchaser's vehicle, purchaser's purchase history, traffic information, turn-by-turn directions, and any combination thereof. While shown in FIG. 1 as being transmitted to a first courier 114, instructions 112 may additionally, or alternatively, be transmitted to a second courier 114, as illustrated.

Instructions 112 may be relayed to at least a courier 114. The instructions 112 may comprise any suitable data including, without limitation, turn-by-turn instructions to a drop-off or delivery location, routing instructions, mapping information, an address, purchase details, order details, delivery instructions, an amount of fuel, user-identifiers such as make and model of a vehicle, license plate number, vehicle color or condition, contact information, cell phone number, GPS coordinates, photographic data, proximity to another courier 114 or fuel recipient 118, etc. In embodiments wherein a courier 114 comprises an autonomous vehicle (e.g., unmanned vehicle, drone, etc.), delivery of fuel may be automated upon arrival of a courier 114 to a delivery location.

Data transmitted from computational hardware linked to a fuel source 108 to a network 104 may comprise available fuel information, confirmation receipts of a transaction, such as a purchase, status, estimated time of arrival, real-time location data of a courier 114, fuel status of a vehicle, real-time or stored location of a fuel recipient 118, combinations thereof, and so forth.

In operation, a fuel delivery system 100 may be used to transport and deliver fuel from a fuel source 108 to a fuel recipient 118 (e.g., a vehicle), such as by deploying fuel from a fuel source 108 to a stranded vehicle, fuel-depleted vehicle, or simply a parked vehicle, to use non-limiting examples. A fuel source 108 may comprise any entity configured to provide pumpable fuel, such as a fuel vendor or gas station. Alternatively, a fuel source 108 may comprise a storage unit, vessel, drum, pipeline, tank, truck (e.g., large tank truck), etc., and/or combinations thereof. The fuel source 108 may comprise, or be systemically coupled to, a fuel generation unit. A fuel generation unit may comprise, for example, a refinery, or one or more industrial components for converting carbon dioxide from the atmosphere to combustible fuel. This may involve, in some examples, a carbon dioxide collector, which may use electrical energy to collect, isolate, and/or react the atmospheric carbon dioxide to form combustible fuel. A single fuel source 108 may be used in a fuel delivery system 100, or multiple. For example, a fuel source 108 may comprise both a high-grade petroleum fuel comprising gasoline with zero ethanol and a low-grade petroleum fuel comprising gasoline and ethanol. Alternatively, a fuel source 108 may comprise two types of fuels having differing octane ratings.

A fuel recipient 118 may comprise any vehicle configured to accept fuel, such as an automobile, a motorboat, a jet ski, a plane, a go-kart, a golf-kart, a motorcycle, a lawnmower, motorized machinery, a tractor, off-roading vehicles, recreational vehicles, combinations, and/or the like. Fuel may be delivered via a fuel delivery pathway 122. Fuel delivery pathway 122 may comprise, for example, a route (e.g., as determined by server 102) between a location of a courier 114 and a location of fuel recipient 118. Conceivably, fuel may be delivered to a fuel recipient 118 while fuel recipient 118 is moving. As illustrated, fuel delivery pathway 122 may comprise multiple delivery pathways, such as from a first courier to a second courier at a first location and a second courier to the fuel recipient 118 at a second location.

Non-limiting examples of suitable types of delivery locations may include, a garage, a side of a road or highway, a road, a driveway, a cul-de-sac, a parking garage, a parking lot, a dirt road, an offroad location, a pin-point on a map, a lake, a bay, the ocean, the beach, and the like. One or more couriers 114 may deliver fuel from a fuel source 108 to a fuel recipient 118 at any location, provided that the location is within travel range of the one or more couriers 114.

Deployment of fuel by a fuel delivery system 100 may be reactionary or anticipatory. In either, data may be transmitted from a mobile device, such as a cell phone, a device built-in or attached or coupled to a vehicle, or the like. Data may or may not be user-specified. Data may include location, purchase information, fuel level, user profile information, photographic data, audio data, user activity data, billing information, user status, fuel level, and/or simply an indication of a need of service, etc. Data may be deliberately conveyed, both automatically monitored and deliberately conveyed, or otherwise both automatically monitored and automatically conveyed.

A courier 114 may comprise an autonomous vehicle, or more simply, may comprise a manned or unmanned vehicle capable of transporting fuel, such as a vehicle driven by a person. In embodiments that include manned vehicles, a person driving a vehicle may receive instructions 112 for a fuel delivery system 100 via a mobile device application, mobile device, and/or an additional graphical user interface, display, or by any other suitable method for relaying communication from one component or system to another or to a person. In other embodiments, an autonomous vehicle may receive instructions 112 from a network 104 seamlessly without a need for human intervention and/or discretion. In yet another embodiment, the courier 114 may comprise a drone, whereby the drone is configured to receive one or more instructions, lift, and transport the fuel, and deliver the fuel to the specified delivery location, for example.

For embodiments wherein deployment is reactionary, data is conveyed to a service provider and/or a server 102, such as by populating one or more fields of a graphical user interface of a mobile device application on a mobile device and subsequently transmitting of a signal through a network. In some a system may be configured for vehicle/home integration to allow for self-ordering gas, such as by automatic deployment upon sensing of a low fuel level in a vehicle.

For embodiments wherein deployment is anticipatory, data such as activity data may be automatically monitored and conveyed. In such embodiments, one or more predictive models may be used to generate a probability of fuel depletion, probability of a need of service, predicted vehicle activity, etc. Predictive models and/or processing algorithms may be based on one or more artificially intelligent algorithms, artificial neural networks, random tree classifiers, machine learning models (e.g., trained using one or more training datasets) or plurality, ensemble, serial arrangement, etc., thereof, and/or the like. Data used in a predictive model may include vehicle fuel gauge information, regional windspeeds, vehicle-estimated gas mileage, driving mode of a vehicle, traffic data, user activity, braking frequency, start-to-stop ratio, accelerometer data, GPS data, user-specified destination in a navigational system, vehicle speed, speed limit, etc. Artificially intelligent algorithms may be used in combination with the present disclosure, such as to predictively model customer demand in one or more regions, to optimize route organization, to automatically deploy couriers 114, and so on. However, in either embodiment, where deployment is reactionary or anticipatory, information 116 may be conveyed to server 102 and/or server 102 via network 104 from a fuel recipient 118, courier 114, and/or fuel source 108. Such information 116 may comprise, for example, purchase information, location data, fuel level (e.g., of a fuel recipient), activity, fuel availability, and/or other data. In addition, information 126 may also be relayed to a fuel recipient in some examples, which may include purchase information, purchase confirmation, ETA of a courier 114, real-time location of a courier 114, fuel availability of a courier 114, combinations thereof, and the like.

Information may be transmitted to a network and subsequently relayed to one or more servers 102. A server 102 may comprise or be otherwise coupled to a computer to convey information thereto. A computer may store information, such as data, within a database 120. Data stored by the database 120 may comprise any of the aforementioned types of data as well as, without limitation, information about a fuel source 108, information about fuel availability, information about a status or location of one or more couriers 114, information about one or more autonomous vehicles, routing and/or mapping information, traffic data, user status, information about previous purchases, information about a vehicle, past order information, fuel source information, driver information, courier information, order processing information, grouping information, predictive modeling data and/or software, other types of data, etc., and/or combinations thereof.

As illustrated in FIG. 1, one or more couriers 114 may be deployed to transport fuel from a fuel source 108 to a fuel recipient 118, such as a vehicle operated by a driver. As discussed, a courier 114 may comprise an unmanned or a manned vehicle, such as an autonomous vehicle or a vehicle driven by a person. A vehicle may be on land, such as a car or plane, or on water, such as a boat or yacht. Prior to delivery and/or deployment, fuel may be pumped or loaded into a tank coupled to a courier 114. After fueling, a courier 114 may be deployed to a target location. A first target location may comprise a hand-off location wherein fuel is transported thereto via a preprogrammed route, transferred from a first courier 114 to a second courier 114, and then transported via route to a fuel recipient 118. Alternatively, a first target location may comprise a delivery location wherein fuel from a fuel source 108 is delivered directly to a fuel recipient 118 via route. One or more specialized fuel nozzles having a customized shape and/or “no-spill” mechanism may be used during fuel delivery to a fuel recipient 118. In embodiments wherein a fuel recipient 118 is on water, a long hose may be used during fuel delivery.

In addition to being equipped with hardware to transport and deliver one or more types of fuel, couriers 114, according to some embodiments of the present disclosure, may be additionally equipped with a mobile convenience store. Additional services may also be included with or substituted for fuel delivery and/or fuel additive delivery, such as oil changes, inspections, appraisals, insurance adjustments, car washes, car maintenance services, a filter change (e.g., air filter, oil filter, etc.), a wiper change, a fluid change (e.g., transmission fluid, brake fluid, wiper fluid, etc.), combinations thereof, and the like. For example, an additional service may comprise one or more services typically performed at or during car shows.

In one example, a courier 114 may be instructed to receive fuel from a fuel source 108. Accordingly, a courier 114 may obtain fuel from or at a fuel source 108 via a fuel acquisition pathway 124. Fuel acquisition pathway 124 may comprise any suitable distance, such as any of the distances described below for delivery pathway 122. Instructions 112 to a courier 114 may, in some examples, include routing information (e.g., generated by a server 102 or 102) to a fuel source 108. An amount of fuel transferred from a fuel source 108 to a courier 114 may comprise any amount, such as less than 1 gallon, less than 2 gallons, less than 5 gallons, less than 25 gallons, less than 50 gallons, less than 100 gallons, less than 200 gallons, more than 200 gallons, and ranges therebetween. The courier 114 may then travel from the fuel source 108 to a fuel delivery location directly or may roam, or park, for one or more intermittent amounts of time until, for example, a fuel deliver order is received by the fuel delivery system 100 of the present disclosure and the instructions to deliver fuel to a fuel recipient relayed to the courier 114. The distance traveled by the courier 114 to a fuel delivery location from a fuel source 108, another courier 114, or an intermittent location may be any suitable distance, for example, between about 0.1 miles and 500 miles. Alternatively, from about 0.1 miles to about 30 miles, about 30 miles to about 90 miles, about 90 miles to about 150 miles, about 150 miles to about 300 miles, about 300 miles to about 500 miles, or any ranges therebetween. Similarly, where the courier 114 is allowed to roam, or otherwise stay put (e.g., parked) in a waiting location until a fuel order is received, any suitable amount of time may elapse between the time at which the courier first obtains fuel from the fuel source 108 and delivers the fuel to either a fuel recipient or another courier. For example, between 1 minute and 36 hours, or alternatively, from about 1 minute to about 30 minutes, about 30 minutes to about 1 hour, about 1 hour to about 3 hours, about 3 hours to about 12 hours, about 12 hours to about 36 hours, or any ranges therebetween.

As alluded to above, a second courier 114 may be instructed to receive fuel from a first courier 114. An amount of fuel transferred from a first courier 114 to a second courier 114 may be any amount, such as less than 1 gallon, less than 2 gallons, less than 5 gallons, less than 25 gallons, less than 50 gallons, less than 100 gallons, less than 200 gallons, more than 200 gallons, or any ranges therebetween.

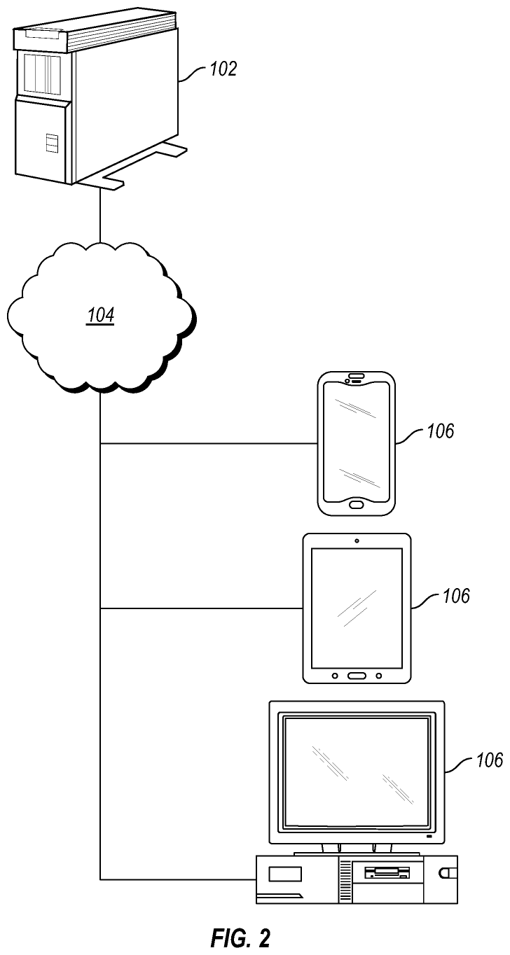

FIG. 2 illustrates a schematic of an integrated system 100 which may comprise one or more processing devices 106 and one or more servers 102. As shown, an integrated system 100 may operate and function to facilitate the sale, procurement of, and/or real-time monitoring of a service including without limitation an on-demand fuel delivery service. Integrated system 100 may include one or more processing devices 106, a network 104, and one or more server 102. Server 102 may be any suitable storage location for program code and related data for applications installed on processing device 106. Server 102 may serve as a host that preserves and provides access to software that has been installed on processing device 106. Server 102 may further operate and function to copy and maintain all files for an application, such as program code, data, and other documents, or may comprise a portion of the files, such as saved data or documents. Server 102 may be implemented on a server 102 using well known components of hardware or software. In some embodiments, information, data, and/or the like may be stored on server 102 in any type of file format. Server 102 may also employ various security features. Server 102 may communicate with processing device 106 through network 104. Network 104 may provide a communication infrastructure between each processing device 106 and server 102. Further, processing device 106 may be any computing device used by a user, such as a mobile telephone, smart-phone, devices built into an automobile, desktop computer, laptop computer, handheld computer, personal digital assistant (PDA) device, media play device, the like, or any mobile device containing one or more transistors.

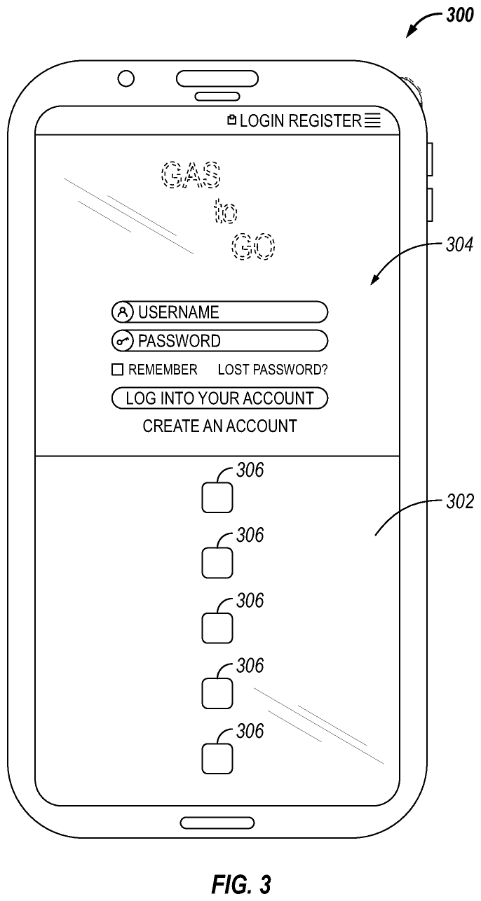

FIG. 3 shows a graphical user interface 300 provided by a processing device 106. As shown, processing device 106 may include a configurable graphical user interface (graphical user interface) home overlay 302. Home overlay 302 may include a login section 304 for identifying a user of processing device 106. A login section 304 may include a username entry form and a password entry form. Both sections may check the user against a database 120 in server 102 (e.g., referring to FIG. 1) to confirm identity and approved access to the application.

Further illustrated in FIG. 3 are a plurality of user interface (UI) buttons 306. UI buttons 306 have a set of system object attributes associated with each UI button 306. Each attribute determines whether a display object for the system object may be rendered in home overlay. This attribute may be set by the system automatically, or by a user input through certain programs or system functionalities. It should be noted that there may be any number of UI buttons 306 for any number of features. Furthermore, the UI buttons 306 may be configured in various ways, for example, such that a user may type one or more word strings into one or more populatable fields, activate dictation (e.g., via voice dictation software) to allow the user to input prompts or commands, select preset options, combinations thereof, or the like.

In embodiments involving a graphical user interface 300, a user may specify a status, need of service, anticipated need of service, anticipated location of a need of service, current location, quantity of fuel desired, type of fuel desired, etc., and/or any data field suitable to trigger generation of a fuel deliver order, fuel deployment, and/or fuel delivery. In some embodiments, a graphic user interface 300 may be tailored for a target user, such as by increasing font sizes and/or adjusting graphical display to accommodate elderly people.

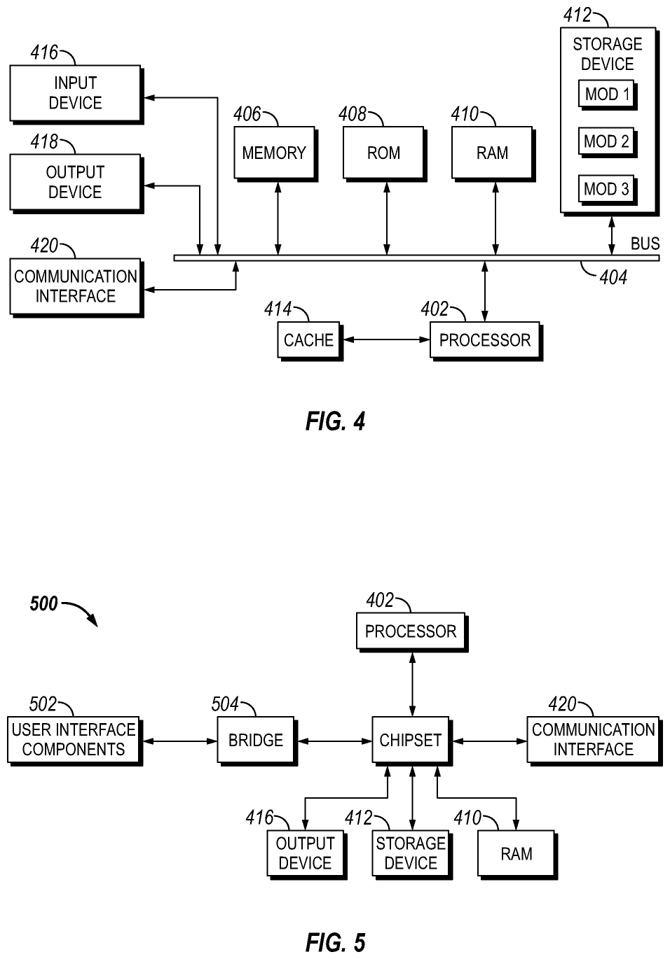

FIG. 4 shows interrelated components of a processing device (e.g., processing device 106 of FIGS. 1-3). As illustrated, a processing device includes a processing unit 402 (CPU or one or more processors) and a system bus 404 that couples various system components including system memory 406 such as read only memory 408 (ROM) and random-access memory 410 (RAM) to processing unit 402. A processing device may include a cache of high-speed memory connected directly with, in close proximity to, or integrated as part of processing unit 402. A processing device copies data from memory 406 and/or storage device 412 to cache 414 for quick access by processing unit 402. In this way, cache 414 provides a performance boost that avoids processing unit 402 delays while waiting for data. These and other modules may control or be configured to control processing unit 402 to perform various operations or actions. Other system memory may be available for use as well. Memory 406 may include multiple different types of memory with different performance characteristics. It may be appreciated that the disclosure may operate on processing device with more than one processing unit 402 or on a group or cluster of computing devices networked together to provide greater processing capability. Processing unit 402 may include any general-purpose processing unit 402 and a hardware module or software module, such as first module, second module, and third module stored in storage device 412, configured to control processing unit 402 as well as a special-purpose processing unit 402 where software instructions are incorporated into processor. Processing unit 402 may be a self-contained computing system, containing multiple cores or processors, a bus 404, memory controller, cache 414, etc. A multi-core processing unit may by symmetric or asymmetric. Processing unit 402 may include multiple processors, such as a system having multiple, physically separate processing units 402 in different sockets, or a system having multiple processing unit cores on a single physical chip. Similarly, processing unit 302 may include multiple distributed processing units 402 located in multiple separate computing devices but working together such as via a communications network. Multiple processing units 402 or processing unit cores may share resources such as memory 406, cache 414, or may operate using independent resources. Processing unit 402 may include one or more state machines, an application specific integrated circuit (ASIC), or a programmable gate array (PGA) including a field PGA (FPGA). Each individual component discussed above may be coupled to system bus 404, which may connect each and every individual component to each other. System bus 404 may be any of several types of bus structures including a memory bus or memory controller, a peripheral bus, and a local bus using any of a variety of bus architectures. A basic input/output (BIOS) stored in ROM 408 or the like, may provide the basic routine that helps to transfer information between elements within processing device, such as during start-up. A processing device may further include storage devices 412 or computer-readable storage media such as a hard disk drive, a magnetic disk drive, an optical disk drive, tape drive, solid-state drive, RAM 410 drive, removable storage devices 412, a redundant array of inexpensive disks (RAID), hybrid storage, or the like. Storage device 412 may include software modules for controlling one or more processors. A processing device may include other hardware or software modules. Storage device 412 is connected to the system bus 404 by a drive interface. The drives and the associated computer-readable storage devices 412 provide nonvolatile storage of computer-readable instructions, data structures, program modules and other data for a processing device. In one aspect, a hardware module that performs a particular function includes the software component stored in a tangible computer-readable storage in connection with the necessary hardware components, such as processor, system bus, and so forth, to carry out a particular function. In another aspect, the system may use a processing unit 402 and computer-readable storage to store instructions which, when executed by the processor, cause the processing unit 402 to perform operations, a method, or other specific actions. The basic components and appropriate variations may be modified depending on the type of device, such as whether a processing device is a small, handheld computing device, a desktop computer, or a computer server. When processing unit 402 executes instructions to perform “operations”, processing unit 402 may perform the operations directly and/or facilitate, direct, or cooperate with another device or component to perform the operations.

As illustrated, a processing device may employ storage device 412, which may be a hard disk or other types of computer-readable storage devices 412 which may store data that are accessible by a computer, such as magnetic cassettes, flash memory cards, digital versatile disks (DVDs), cartridges, random access memories 410 (RAMs), read only memory 408 (ROM), a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

As illustrated, each individual component described above is depicted and disclosed as individual functional blocks. The functions these blocks represent may be provided through the use of either shared or dedicated hardware, including, but not limited to, hardware capable of executing software and hardware, such as a processor, that is purpose-built to operate as an equivalent to software executing on a general-purpose processor. For example, the functions of one or more processing units 402 presented in FIG. 4 may be provided by a single shared processing unit 402 or multiple processors. (Use of the term “processor” should not be construed to refer exclusively to hardware capable of executing software.) Illustrative embodiments may include microprocessor and/or digital signal processor (DSP) hardware, read-only memory 408 (ROM) for storing software performing the operations described below, and random-access memory 410 (RAM) for storing results. Very large-scale integration (VLSI) hardware embodiments, as well as custom VLSI circuitry in combination with a general-purpose DSP circuit, may also be provided.

The logical operations of the various methods, described below, are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. A processing device may practice all or part of the recited methods, may be a part of the recited systems, and/or may operate according to instructions in the recited tangible computer-readable storage devices 412. Such logical operations may be implemented as modules configured to control processing unit 402 to perform particular functions according to the programming of software modules.

In examples, one or more parts of an example processing device, up to and including the entire processing device, may be virtualized. For example, a virtual processing unit may be a software object that executes according to a particular instruction set, even when a physical processing unit 302 of the same type as the virtual processing unit is unavailable. A virtualization layer or a virtual “host” may enable virtualized components of one or more different computing devices or device types by translating virtualized operations to actual operations. Ultimately however, virtualized hardware of every type is implemented or executed by some underlying physical hardware. Thus, a virtualization compute layer may operate on top of a physical compute layer. The virtualization compute layer may include one or more virtual machines, an overlay network, a hypervisor, virtual switching, and any other virtualization application.

FIG. 5 illustrates an example of a processing device (e.g., processing device 106 of FIG. 1) having a chipset architecture 500 that may be used in executing the described method and generating and displaying a graphical user interface (e.g., graphical user interface 300 of FIG. 3). A processing device is an example of computer hardware, software, and firmware that may be used to implement the disclosed technology. A processing device may include a processing unit 302, representative of any number of physically and/or logically distinct resources capable of executing software, firmware, and hardware configured to perform identified computations. Processing unit 402 may communicate with a chipset architecture 500 that may control input to and output from processing unit 402. In this example, chipset architecture 500 outputs information to output device 416, such as a display, and may read and write information to storage device 412, which may include, for example, magnetic media, and solid-state media. Chipset architecture 500 may also read data from and write data to RAM 410. A bridge 504 for interfacing with a variety of user interface components may be provided for interfacing with chipset architecture 500. Such user interface components may include a keyboard, a microphone, touch detection and processing circuitry, a pointing device, such as a mouse, and so on. In general, inputs to a processing device may come from any of a variety of sources, machine generated and/or human generated.

Chipset architecture 500 may also interface with one or more communication interfaces that may have different physical interfaces. Such communication interfaces may include interfaces for wired and wireless local area networks, for broadband wireless networks, as well as personal area networks. Some applications of the methods for generating, displaying, and using the graphical user interface disclosed herein may include receiving ordered datasets over the physical interface or be generated by the machine itself by processing unit 402 analyzing data stored in storage device 412 or RAM 410. Further, a processing device may receive inputs from a user via user interface components 502 (e.g., input device 416 of FIG. 4) and execute appropriate functions, such as browsing functions by interpreting these inputs using processor 402.

In examples, a processing device may also include tangible and/or non-transitory computer-readable storage devices 412 for carrying or having computer-executable instructions 112 or data structures stored thereon. Such tangible computer-readable storage devices 412 may be any available device that may be accessed by a general purpose or special purpose computer, including the functional design of any special purpose processing unit 302 as described above. By way of example, and not limitation, such tangible computer-readable devices may include RAM 410, ROM 408, EEPROM, CD-ROM or other optical disk storage, magnetic disk storage or other magnetic storage devices 412, or any other device which may be used to carry or store desired program code in the form of computer-executable instructions, data structures, or processing unit chip design. When information or instructions are provided via a network (e.g., instructions 112 of FIG. 1), or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices 412.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc., that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processing unit systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices 412.

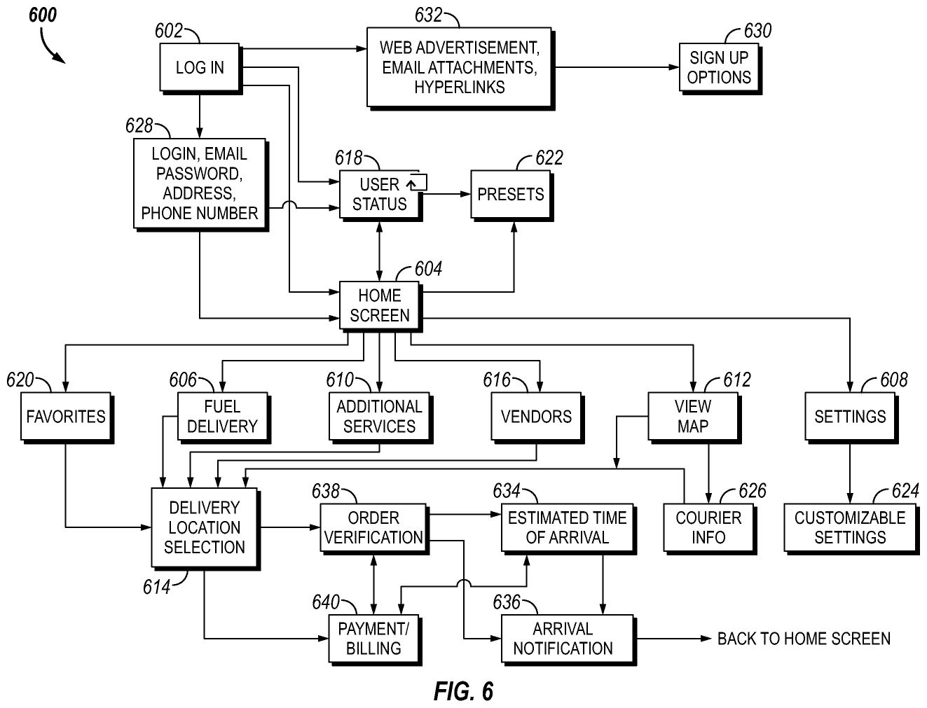

FIG. 6 is a workflow 600 for an integrated approach to the marketing, sale, monitoring, and delivery of a fuel delivery service, in accordance with one or more examples. Certain embodiments of the present disclosure may or may not adhere to a process flow as shown in workflow 600 but may include additional primary and/or secondary features, or may omit illustrated features to carry out the purposes of fuel delivery systems and methods described herein. Herein, a “block” may refer to a component or sub-architecture of a software, such as one logical hub and/or processing module embedded within a programmable architecture. For example, a block may be equipped with links and/or display features configured to enable a user to move between various functionalities and/or other sub-architectures within an application and/or software, including without limitation, between a service selection module and an information display module, or between a service selection module and an order verification or monitoring module. Herein, a “block” and a “module” may be used interchangeably. For the purposes of this disclosure, any block shown in FIG. 6 may be functionally linked and/or connected to any other block such that a user may navigate between the two blocks at leisure.

During implementation, workflow 600 may begin with a user accessing the software application in a block 602 by logging into the application. Logging into the application may require a user to provide a password, biometric scan, face identification, finger scan, dual login verification, any combination thereof and/or the like. By logging into the software in block the user may be able to access base features, access a home screen block, and/or access a user status block. One or more base features may be displayed on a home screen block 604. Base features may include without limitation, fuel delivery services in block 606, settings in block 608, additional services in block 610, current location and/or a viewable map in block 612, delivery location selection in block 614, vendor selection in block 616, user status in block 618, favorites in block 620, and/or any other requisite module, block, sub-architecture, link, overlay, or programmable pathway within the software.

A home screen may be configured to render a home overlay 302 (e.g., referring to FIG. 3). As discussed, one or more base features may be functionally linked to home screen, such as by rendering one or more base feature icons within a home overlay 302. Selection by a user of such icons and/or any other secondary feature may be performed via any suitable method including, without limitation, capacitive sensing, buttons (e.g., graphical user interface buttons 306 of FIG. 3), voice to text, user selection, and the like.

Upon selection of a base feature, a user may proceed to place orders, update profile and/or billing information, select additional services, select a vendor, establish a delivery location, repeat a previous order, view a current location, view locations of one or more nearby couriers, determine application preferences, combinations thereof, and the like. While certain pathways between features of workflow are shown in FIG. 6, it should be understood that certain pathways not shown may be undertaken, provided that such pathways logically follow to fulfill an intended purpose of the software such as, without limitation, placement and/or monitoring of a fuel delivery order. In addition, an illustration of a certain pathway between a first block “A” and a second block “B” may or may not preclude one or more additional blocks, e.g., block “C” from being disposed in between A and B.

A base feature may comprise settings. In block 608 for settings, a user may be able to adjust or specify certain aspects of a software to customize features therein according to a user's preferences. For example, login passwords may be changed, email communication may be programmed, contact information such as phone numbers and addresses may be added, permissions may be granted, credit card and/or other billing information may be stored, default delivery location(s) may be programmed, application preferences may be determined, and/or the like. Additionally, settings block 608 may be used to adjust how a user views and interacts with the software. For example, a user may adjust an order of base feature icons, modify one or more types of base features rendered on a home screen, determine whether or not to skip one or more steps in a workflow pathway (i.e., skipping an order verification step), select display features, configure one or more programmable presets, e.g., of presets block 622, select application default preferences, and so on. Adjustment of how a user views and interacts with the software may be controlled by user interaction with a graphical user interface display rendered by a customized settings selection block 624.

A base feature may additionally or alternatively comprise a fuel delivery service selection block 606. In fuel delivery service selection block 606, a user may view or select available delivery services including, without limitation, nearby vendors, nearby couriers, types of available fuel gasoline, diesel fuel, bio-diesel fuel, ethanol, synthetic fuel, electro-fuel, and combinations thereof, estimated time of arrival, vendor ratings, courier ratings, etc. A user may view or select fuel additives including, without limitation, octane, acetone, ether, nitrous oxide, fuel stabilizers, fuel injector cleaners, diesel exhaust fluid, nitromethane, butyl rubber, ferox, oxyhydrogen, ferrous picrate, tetranitromethane, anti-foaming agents, antioxidants, hybrid compound blends, oxygenates, antiknock agents, lead scavengers, fuel dyes, metal deactivators, corrosion inhibitors, and any combinations thereof.

An additional or alternative base feature may comprise an additional service block 610. In an additional service block, a user may view or select available additional services including, without limitation, oil changes, car washes, mobile convenience store delivery, car maintenance, insurance adjustments, appraisals, combinations, and/or the like. Additional services may include any deliverable service or deliverable product.

A base feature may additionally or alternatively comprise a vendor selection block 616. In a vendor selection block, a user may view or select nearby vendors, prices, client ratings, types of fuels or products offered, available quantity of fuel or products, combinations, and/or the like.

A base feature may additionally or alternatively comprise a user status block 618. A user status base feature may add convenience and/or functionality to a software, such as by enabling rapid selection of services and/or auto-populating of graphical user interface display interaction. A user status module may include, without limitation, “out-of-gas,” “low-on-gas,” “full tank”, “quarter tank,” “check engine light,” “oil light,” combinations, and/or any other suitable user status option, provided that the option indicates a current or anticipated state of a user. Upon selection of a status, a user may proceed to one or more programmable presets. A preset herein refers to any predetermined pathway through a workflow to enable a user to quickly navigate between two or more elements of a software, such as, without limitation, by proceeding directly to a later stage in a workflow (e.g., delivery location selection, estimated time of arrival, etc.). Presets may be selected and/or programmed by a user or application developer from within a base feature, secondary feature, and/or during programming of a software application. Programmable presets may be built in to or may altogether comprise a customizable setting of a software architecture.

For example, a base feature having one or more programmable presets may comprise a favorites block 620. As mentioned, a favorites block 620 may, among other things, add convenience and/or functionality to a software, such as by allowing for alternative streamlined pathways through a workflow to achieve rapid selection of services. For example, favorites block 620 may have functionality embedded therein to enable executable instructions including, without limitation, repetition of a previous selection made by a user by the software, carrying out of a trendy selection based on other users' selections (i.e., within a geographical region), automatic ordering of a service to a home location, selection of a preferred vendor, displaying of a particular module, auto-populating of one or more fields in a graphical user interface, displaying of service or delivery options within a geographical area, and/or any other selection of streamlined pathways through a workflow, provided that the selected pathways comprise at least one automatic selection. For example, if a location of a user is within a certain radius of a predetermined location, a favorite software input such as a fuel delivery option to the predetermined location may appear at the top of a list of favorites.

A base feature may additionally or alternatively comprise a delivery location selection block 614. Upon selection of delivery location selection block 614, a user may be presented with delivery location options, such as a current location, future locations estimated enroute during navigation, a location indicated by a pin dropped on a map, an address, coordinates, cross streets, a place of business, a place of residence, or the like. A user may then select a delivery location and proceed to any of payment/billing information block 640, user profile information block, vendor selection block, fuel delivery service selection block, order verification module, or may proceed directly to estimated time of arrival block.

A base feature may additionally or alternatively comprise a current location block 612. Current location block 612 may be utilized to display a location, such as with a scrollable map. Current location block 612 may include, without limitation, any display of a current location, a display of one or more vendor locations, a display of locations of one or more couriers, combinations, and/or the like. Features may be integrated into current location block 612 to enable a user to select and/or view venders, couriers, and service availability. In some embodiments, information such as courier and/or vendor information (i.e., location, service availability, prices, etc.) may be displayed in a current location block without proceeding to courier information block 626.

Upon making any selection within workflow 600, a user may, at any moment, return to a home overlay at block 604. In the event that user-selections were made before following through to completion of an order (i.e., such as before following through to completion of an order and subsequent transitioning to order verification block 638, by transitioning to arrival notification etc.), a portal may be rendered by any block within workflow 600 to enable a user to resume a purchase and/or continue where the user left off.

It should also be understood that a transition to and/or from any of one block to another may depend on any of internal settings, permissions, software usage history, user-selections, previous user-selections, combinations, and/or the like.

With continued reference to FIG. 6, workflow 600 may comprise secondary features in addition to or replacement of base features. Secondary features may include, without limitation, a password block 628, sign up options block 630, advertising block 632, user profile information block, order verification block 638, estimated time of arrival block 634, arrival notification block 636, and courier information block 626. Secondary features may contribute to the functionality of the software, such as by allowing individual users to create an account, by verifying a purchase, by displaying an estimate of a delivery time, by alerting a user as to when a courier has arrived at a delivery location, by displaying information about a courier, by requiring a password, combinations thereof, and/or the like. Secondary features may be included and/or implemented throughout a workflow in any suitable manner including, without limitation, according to illustrations given by FIG. 6. Election of either a base feature or a secondary feature by cause a software to render a second overlay and generate displayable data therein.

Systems and methods for a fuel delivery service may be implemented by a software, such as by a software having an architecture configured to execute a workflow. A software may comprise an application, such as a downloadable application for a mobile device, or may simply be loaded via any suitable method to a processing device. Alternatively, a processing device may comprise any computing device including, without limitation, a mobile telephone, a smart-phone, devices built into an automobile, a desktop computer, a laptop computer, a handheld computer, a personal digital assistant (PDA) device, a media play device, the like, and/or any mobile device containing one or more transistors.

### EXAMPLES

The following examples are intended to demonstrate a few of many possible pathways for a user to traverse the software, highlighting various inputs and outputs.

In one example, a user creates an account and logs in with a username and password before proceeding to a home page. The user selects an icon on the home page and then proceeds to a display showing vendors and fuel. The user selects a vendor, selects fuel and proceeds to a display showing multiple delivery locations. The user selects a delivery location and proceeds to a display requesting billing information. After populating the required fields with billing information, the user proceeds to a display requesting order verification. The user verifies the order and proceeds to a display showing an estimated time of arrival of a fuel delivery service. The user then proceeds to a display showing a notification that the fuel delivery service has arrived when a courier arrives at the specified delivery location.

In another example, a user selects a favorites icon on the home page. The user proceeds to a display wherein various service options are presented. The user selects an option and proceeds directly to a display showing an estimated time of arrival of a fuel delivery service.

In another example, a user selects a status icon on the home page. The user proceeds to a display wherein various status options are presented. The user selects a status option and then proceeds to a display showing a current location. The user selects a location and then proceeds to an order verification display. The user verifies the order and proceeds to a display showing estimated time of delivery.

In another example, a user selects a navigation icon on the home page. The user selects an icon on a map to view information and service options. The user selects a service and then proceeds to a display showing an estimated time of arrival.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

Advantages of the present disclosure include, without limitation, ease of access to mobile delivery of fuel, fuel additives, and/or a vehicle service. Specifically, the software application of the present disclosure may enable a purchaser and/or fuel recipient to bypass conventional methods of obtaining fuel by allowing a fuel delivery system to service the fuel recipient quickly, and at a specified location. The specified location may comprise locations which would be otherwise beyond the reach of a would-be fuel recipient. It is contemplated, for example, that at least a cross country traveler with insufficient fuel to reach a far-away gas station may benefit of the software application and associated methods and systems of the present disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. A method comprising:
providing access to a software application stored at an offsite storage location to one or more processing devices, the software comprising architecture, wherein the architecture is configured to display a home overlay, one or more additional overlays, and data from a database;
allowing a user to download the software to the one or more processing devices;
fulfilling a service request based on a service selection made by the user, wherein the service request comprises at least delivery of one or more combustible fuels to a fuel recipient at an identified location.

2. The method of claim 1, further comprising:
allowing the user to log in to a personalized account with a username and password;
directing the user to a home screen, wherein the home screen is configured to allow the user to request an order of the one or more combustible fuels;
directing the user to a fuel delivery page, wherein the user is prompted to customize the order of fuel;
directing the user to a delivery location selection page, wherein the user is prompted to select the identified location; and
directing the user to a payment billing page, based at least in part on the order of the one or more combustible fuel, wherein the user is provided with a receipt of payment, an order confirmation, and/or an arrival notification.

3. The method of claim 1, wherein the software application is configured to display, on the one or more processing devices, a graphical user interface, wherein the graphical user interface comprises at least the home overlay and the one or more additional overlays.

4. The method of claim 3, wherein the home overlay comprises one or more data entry fields for inputting a username and password, and a registration option for new users.

5. The method of claim 4, wherein the display of information comprises a plurality of user interface buttons.

6. The method of claim 5, wherein the software application, when one or more of the interface buttons are selected, is configured to direct the user to the one or more additional overlays, wherein the one or more additional overlays comprise a favorites overlay, a fuel delivery overlay, an additional services overlay, a vendors overlay, a view map overlay, and an overlay displaying one or more customizable settings.

7. The method of claim 1, wherein upon making the fuel delivery order, an order verification is sent to the user along with a payment billing confirmation.

8. The method of claim 7, wherein the user is provided with an estimated time of arrival notification after receiving the order verification and/or the payment billing confirmation.

9. The method of claim 8, wherein the user is further provided with a notification of arrival when a courier has arrived at the identified location.

10. The method of claim 1, wherein the software application is configured to allow the user to return to the home overlay from any of the one or more additional overlays.

11. The method of claim 1, wherein the software application is configured to allow the user to cancel, at any point in time until after fulfillment of the service request, the order for fuel.

12. The method of claim 1, wherein the software application is configured to allow the user to communicate with a courier driver via messaging.

13. The method of claim 1, wherein one or more servers maintain all files for an application, program code, data, and documentation during running of the software application on the one or more processing devices.

14. The method of claim 13, wherein the one or more servers employ at least one security feature.

15. The method of claim 14, wherein a network provides a communication infrastructure between the one or more processing devices and the one or more servers.

16. The method of claim 1, wherein the one or more processing devices comprise at least one device selected from the group consisting of a mobile telephone, a smart-phone, one or more devices built into an automobile, a desktop computer, a laptop computer, a handheld computer, a personal digital assistant device, a media play device.

17. The method of claim 1, wherein the home overlay and/or at least one of the one or more additional overlays are configured to present to the user a plurality of fuel type delivery options, wherein the plurality comprises at least one fuel type selected from the group consisting of unleaded gasoline, diesel, bio-diesel, ethanol, synthetic fuel, e-fuel, carbon-captured fuel, race gas, treated gas, natural gas, high octane rated fuel, low octane rated fuel, zero-ethanol rated fuel, hydrogen, and any combination thereof.

18. The method of claim 1, wherein the home overlay and/or at least one of the one or more additional overlays are configured to present to the user a plurality of fuel additive type delivery options, wherein the plurality comprises at least one fuel additive type selected from the group consisting of octane, acetone, ether, nitrous oxide, a fuel stabilizer, a fuel injector cleaner, diesel exhaust fluid, nitromethane, a detergent, a catalyst, a ring sealer, butyl rubber, oxyhydrogen, ferrous picrate, tetranitromethane, an anti-foaming agent, an antioxidant, an oxygenate, an antiknock agent, a lead scavenger, a metal deactivator, a corrosion inhibitor, and any combination thereof.

19. The method of claim 1, wherein the home overlay and/or at least one of the one or more additional overlays are configured to present to the user a plurality of vehicle service options, wherein the plurality comprises at least one vehicle service type selected from the group consisting of an oil change, a vehicle inspection, an appraisal, an insurance adjustment, a car wash, a car maintenance service, a filter change, a wiper change, a fluid change, and any combination thereof.

20. A software application comprising:
architecture, wherein the architecture is configured to display a home overlay, one or more additional overlays, and data from a database;
wherein the software application is configured to trigger fulfillment of a service request based on a service selection made by a user, wherein the service request comprises at least delivery of one or more combustible fuels to a fuel recipient at an identified location.
